(19) United States
(12) Patent Application Publication
(10) Pub. No.: US 2002/0044027 A1
(43) Pub. Date: Apr. 18, 2002

(54) SWITCHABLE INDUCTOR

(76) Inventors: SHU-ANG ZHOU, ALVSJO (SE); ERLAND WIKBORG, DANDERYD (SE)

Correspondence Address: NIXON & VANDERHYE PC, 1100 NORTH GLEBE ROAD, 8TH FLOOR, ARLINGTON, VA, 222014714

(21) Appl. No.: 09/353,649

(22) Filed: Jul. 15, 1999

(30) Foreign Application Priority Data
Jul. 17, 1998 (SE) 9802583-6

(51) Int. Cl. H01P 3/08; H01B 12/02

(52) U.S. Cl. 333/99 S; 333/238; 505/210; 505/701

(57) ABSTRACT

An inductor for microwave frequencies has a substantially planar structure and is constructed of a transmission line designed as a linear microstrip element made of a central line comprising normal electrically conducting material, such as a suitable metal. The microstrip element has a width which is varied by making areas at sides of the central line superconducting. In changing the effective width of the microstrip the inductance thereof is changed accordingly. The areas at the sides of the microstrip element are located directly at the central, normal metal conductor. These areas have in the non-superconducting state some electrical conductivity which can be rather low but owing to the fact that they contact the normal central metal conductor only at a very narrow edge instead of contacting it at a large surface they do not significantly affect the transmission characteristics of the transmission path when the superconducting areas are in their normal state.

The present invention relates to an inductor to be used in microwave integrated circuits, in particular an inductor being formed by a microstrip line

### BACKGROUND

In transmission paths in microwave integrated circuits there is of course a need for various components such as inductors like in other electronic fields. In particular there may be a need for an inductor, the characteristics of which can be varied, such as an inductor which can be switched between two inductance values as controlled by an electrical signal.

In Japanese patent application JP 2/101801 a microwave band-rejection filter is disclosed having transmission lines designed as linear microstrip, metal elements placed on top of an area of a layer of the superconducting material. The superconducting material area has a pattern substantially agreeing with that of the metal conductor except in some regions where the width of the superconducting area is larger than that of the metal conductor. When the superconducting material is made to pass into a non-superconducting state, most of the electric current passes through the common metal material of the metal conductor whereas, in the superconducting state, the electrical current passes only through the superconducting underlying material. The elements thereby obtain a variable filtering effect. However, a disadvantage of this design resides in providing a region having some, though it may be low, electrical conductivity placed under the normal conductor, since this region causes losses in the transmission line. The conductivity of materials, which are superconducting at a low temperature and are suitable for microwave integrated circuits, have in their normal state an electrical conductivity corresponding to some 10⁻³ to 10⁻² of the electrical conductivity of the material of the always normal metal conductor.

### SUMMARY

It is an object of the invention to provide an electrical inductor of the microstrip type for microwaves exhibiting low losses.

Thus, an inductor for primarily microwave frequencies is constructed of a transmission line designed as a linear microstrip element made of a central line comprising normal electrically conducting material, such as a suitable metal. The microstrip element has a width which is varied by making areas at the sides of the central line superconducting. In changing the effective width of the microstrip the inductance thereof is changed accordingly. The areas at the sides of the microstrip element are located directly at the central, normal metal conductor and are thus electrically connected thereto along at least portions of the sides or of the edges of the central, normal metal conductor. These areas have in their non-superconducting state some electrical conductivity which can be rather low but owing to the fact that they contact the normal central metal conductor only at a very low, thin or narrow edge instead of contacting it at a large surface they do not significantly affect the transmission characteristics of the transmission path when the superconducting areas are in their normal, not superconducting state.

Additional objects and advantages of the invention will be set forth in the description which follows, and in part will be obvious from the description, or may be learned by practice of the invention. The objects and advantages of the invention may be realized and obtained by means of the methods, processes, instrumentalities and combinations particularly pointed out in the appended claims.

### BRIEF DESCRIPTION OF THE DRAWINGS

While the novel features of the invention are set forth with particularly in the appended claims, a complete understanding of the invention, both as to organization and content, and of the above and other features thereof may be gained from and the invention will be better appreciated from a consideration of the following detailed description of non-limiting embodiments presented hereinbelow with reference to the accompanying drawings, in which:

FIG. 1 is a cross-sectional view of a planar, switchable microwave inductor,

FIG. 2a is a cross-sectional view identical to that of FIG. 1 illustrating electrical current distribution when some regions are in a superconducting state,

FIG. 2b is a cross-sectional view similar to that of FIG. 2a illustrating electrical current distribution when some regions have changed from a superconducting state to a normal state, and

FIG. 3 is a diagram of the inductance of an inductor as a function of time illustrating the case where some regions of an inductor change from a superconducting state to a normal state.

### DETAILED DESCRIPTION

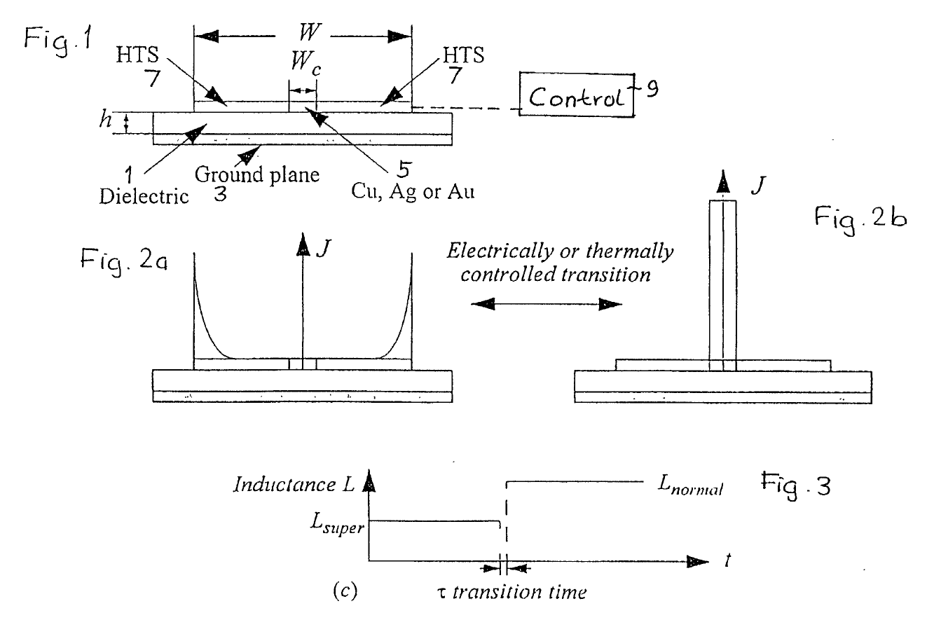

In the cross-sectional view of FIG. 1 an inductor having a variable inductance intended to be connected in e.g. a microwave circuit is illustrated. The inductor is built on a dielectric substrate 1 having an electrically conducting ground layer 3, such as a metal layer of e.g. Cu, Ag or Au, on its bottom surface, the ground layer covering substantially all of the bottom surface as a contiguous layer. On the top surface there is a patterned electrically conducting layer 5 having a high electrical conductivity, such as a suitable metal, e.g. of the same metal as the bottom layer, i.e. of copper, silver or gold. The patterned layer 5 has the shape of strip of uniform width W_{C} and forms a transmission or propagation path for microwaves. The strip 5 has electrically conducting areas or regions 7 located directly at the side or sides of the conductor strip 5. These regions 7 are made of a potentially superconducting material, preferably a high temperature superconducting material. The regions 7 comprise strips located at both sides of the central metallic strip 5, preferably symmetrically in relation thereto, these strips thus having the same uniform width as each other. The width of the superconducting strips together with the central conductor is denoted by W.

In the normal state of the potentially superconducting regions 7 they have, for typical high temperature superconductivity materials, an electrical conductivity σₙ of about 5•10⁵ S/m to be compared to the electrical conductivity σ_{c} of the central metal conductor 5 comprising about 10⁸ S/m. In the case where the potentially superconducting regions 7 are in a normal state, the electrical current will accordingly flow almost entirely in the central conductor 5. The current distribution for this non-superconducting state appears from the diagram of FIG. 2b. The current distribution is here substantially uniform over the width WC of the conductor 5.

In the other case where the regions 7 are in a superconducting state, all of the electrical current will only pass in the lateral superconducting areas 7 and at the outer edges thereof, see the current distribution diagram of FIG. 2a, according to the Meissner effect.

The inductance of a microstrip line is mainly determined by the total width w of the line, e.g. being approximately inversely proportional to the width, i.e. approximately proportional to 1/w, provided that the height h of the microstrip line to its ground plane 3 is fixed. Thus, changing the state of the potentially superconducting regions 7 to enter and to leave the superconducting state will change the inductance of the microstrip line as described hereinabove, the inductance then adopting a lower and a higher value respectively, see the diagram of FIG. 3.

A switching between the superconducting state and the normal state of the potentially superconducting regions 7 can be achieved in any conventional way, such as by varying the temperature, by varying the magnetic field or by varying a direct current level as to what is required or desired. This switching is symbolized by the control unit 9 shown in FIG. 1. A preferred way may be to have the control unit make an electrical current higher than the critical current of the superconducting material pass or not pass through the microstrip line. By letting always a fixed bias current, a direct current, pass through the line, the fixed bias current having an intensity slightly slower than that of the critical current, and adding or not adding thereto a small control current such as a current pulse, the reversible switching between the superconducting state and the normal state can be made extremely fast. The general appearance of the switching operation appears from the diagram of FIG. 3. Here, first the regions 7 of the microstrip line are in a superconducting state, the microstrip line have a first low inductance Lsuper and then the state is changed to normal, producing a change of the inductance to a higher value Lₙₒᵣₘₐₗ. Then there is a small transition time τ before the change of inductance is actually effected, for instance when the current through the microstrip line is suddenly increased.

Numerical simulation has indicated that the inductance L of a microstrip line can be easily increased to its double value for a suitable width of the superconducting regions 7, working at microwave frequencies.

While specific embodiments of the invention have been illustrated and described herein, it is realized that numerous additional advantages, modifications and changes will readily occur to those skilled in the art. Therefore, the invention in its broader aspects is not limited to the specific details, representative devices and illustrated examples shown and described herein. Accordingly, various modifications may be made without departing from the spirit or scope of the general inventive concept as defined by the appended claims and their equivalents. It is therefore to be understood that the appended claims are intended to cover all such modifications and changes as fall within a true spirit and scope of the invention.

What is claimed is:

1. An inductor for microwaves, the indictor comprising:
a central microstrip line made of an electrically conducting material exhibiting no superconducting properties above a considered temperature; and
regions made of a material exhibiting superconducting properties above the considered temperature, the regions being located at sides of the central microstrip line and in the same plane as the central microstrip line.

2. The inductor of claim 1, wherein the central microstrip line has a shape of a strip of a uniform width.

3. The inductor of claim 1, wherein the regions have shapes of strips of uniform widths.

4. The inductor of claim 3, wherein all the regions have a same width.

5. The inductor of claim 1, further comprising control means for making an electrical current flow through the inductor, thereby bringing, when the inductor is above the considered temperature and the regions are in a superconducting state, the regions to change to a non-superconducting state.
